(19) United States
(12) Patent Application Publication
(10) Pub. No.: US 2016/0293946 A1
(43) Pub. Date: Oct. 6, 2016

(54) ELECTRODE MATERIAL WITH LITHIUM-ARGYRODITE

(71) Applicant: ROBERT BOSCH GMBH, Stuttgart (DE)

(72) Inventors: Helene Ritter, Bamberg (DE); Tjalf Pirk, Stuttgart (DE); Olivier Schecker, Stuttgart (DE)

(21) Appl. No.: 15/022,442

(22) PCT Filed: Sep. 2, 2014
(86) PCT No.: PCT/EP2014/068558

§ 371 Date: Jun. 22, 2016

(30) Foreign Application Priority Data
Sep. 27, 2013 (DE) 10 2013 219 606.7

(51) Int. Cl. H01M 4/485; H01M 4/62; H01M 4/133; H01M 4/505; H01M 4/525; H01M 4/587; H01M 4/1315; H01M 10/0525

(52) U.S. Cl. CPC H01M 4/485; H01M 4/1315; H01M 4/623; H01M 4/624; H01M 10/0525; H01M 4/505; H01M 4/525; H01M 4/587; H01M 4/133; H01M 2300/0071

(57) ABSTRACT

An electrode material for a lithium cell, in particular a dry-cell battery cell, includes at least one lithiatable electrode active material. To improve the performance of a cell equipped with this material, the material additionally includes at least one organic binder, and at least one solid lithium-ion conductor selected from the group of lithium argyrodites and lithium ion conducting glasses. Also described is a lithium cell and battery, and the use thereof.

### FIELD OF THE INVENTION

The present invention relates to an electrode material, a lithium cell and lithium battery, in particular, a dry-cell battery cell, and a use of the same.

### BACKGROUND INFORMATION

Liquid electrolyte batteries are typically configured on the basis of porous composite electrodes which contain active material (storage material). Here, pores occupy a large proportion of the volume of the electrodes. Liquid electrolyte, which transports ions between the active materials and the electrodes, is introduced into the pores.

Dry-cell batteries or solid state batteries represent another battery type and have compact electrode layers made of pure active material, a solid electrolyte being situated between the electrode layers.

Patent document DE 10 2011 076 177 A1 discusses a layer arrangement including a solid electrolyte layer situated between two electrode layers.

### SUMMARY OF THE INVENTION

The subject matter of the present invention is an electrode material, for example, a cathode material or an anode material, for a lithium cell, in particular, for a dry-cell battery cell, which includes at least one lithiatable electrode active material, for example, cathode active material or anode active material, at least one, in particular, organic binder, and at least one solid lithium-ion conductor.

A lithium cell may be understood, in particular, to be an electrochemical cell whose anode (negative electrode) includes lithium. For example, it may be a lithium-ion cell, a cell whose anode (negative electrode) includes an intercalation material, for example, graphite, in which lithium is reversibly storable and removable, or a lithium-metal cell, a cell with an anode (negative electrode) made of metallic lithium or a lithium alloy. In particular, the lithium cell may be a lithium-ion cell.

A lithiatable material may be understood, in particular, as a material which may reversibly accommodate and release lithium ions. For example, a lithiatable material may be intercalatable with lithium ions and/or may be alloyable with lithium ions and/or may accommodate and release lithium ions in phase transformation. For example, the lithiatable electrode active material may be an electrode active material which is intercalatable with lithium ions.

The lithiatable electrode active material may also be referred to as active storage material. For example, the electrode active material may store the lithium ion in the simultaneous presence of a lithium ion (Lil and an electron, which is also referred to as intercalation, and, depending on the voltage, release it again, which is also referred to as deintercalation. The lithium ion may thereby be released from the electrode active material to the solid lithium-ion conductor or removed from the latter.

The solid lithium-ion conductor may thereby advantageously take on the function of an ionic conductor network in order to ensure ion transport in the electrode material.

The at least one solid lithium-ion conductor may, for example, be selected from the group of lithium argyrodites, lithium ion conducting glasses, and lithium ion conducting ceramics, in particular, having a garnet structure, for example, lithium lanthanum zirconium oxides and/or lithium lanthanum tantalum oxides, in particular,—if necessary doped—lithium lanthanum zirconium garnets and/or lithium lanthanum tantalum garnets (LiLaZrO, LiLaTaO).

In particular, the at least one solid lithium-ion conductor may be selected from the group of lithium argyrodites and lithium ion conducting glasses. Thus, the long-term stability and/or performance, for example, the energy content and/or performance content of a cell or battery equipped with the electrode material, in particular, a dry-cell battery, for example, based on lithium ions may be advantageously improved.

This is based, in particular, in that lithium argyrodites and lithium ion conducting glasses advantageously have a high lithium ion conductivity and low contact transition resistances, which advantageously affects the ionic conduction. In particular, lithium argyrodites and lithium ion conducting glasses may advantageously have a higher lithium ion conductivity and, in particular, lower contact transition resistances than lithium phosphorus oxynitride (LiPON) and lithium ion conducting ceramics with garnet structures.

Due to an improved ionic conduction, a faster distribution of the lithium ions may in turn be advantageously achieved, and thus the load of the battery, at the same power profile called, may be reduced both transversally through the battery and also laterally and thus the service life is increased. Due to a reduction of the transversal load, the voltage curve of the cells may thereby be additionally advantageously improved. Due to a reduction of the lateral load, local voltage peaks may thereby be minimized.

The improved ionic conduction, however, also advantageously enables a reduction of the solid lithium-ion conductor proportion and thereby an increase in the electrode active material proportion and thus the energy density while maintaining the total ionic conduction.

In addition, lithium argyrodites and lithium ion conducting glasses may advantageously be manufactured in a simple way, in particular, in powder form, in particular, in cases when a complex sputtering, for example, a complex high-temperature synthesis, may be omitted.

As a result that the electrode material includes the solid lithium-ion conductor, a liquid electrolyte may also be advantageously omitted and, in particular, a dry-cell battery cell may be formed. Thus, good aging characteristics, in particular, a high long-term stability, and a long service life of the cell may again be advantageously achieved. In addition, the intrinsic safety of the cell may thus advantageously be improved. Furthermore, the temperature range, at which the cell may be used, may be advantageously expanded to higher temperatures, for example, 80° C., whereby transition resistances and the ionic conductivity, and thus the long-term stability and performance may again be further improved.

Due to the at least one, in particular, organic binder, the cohesion of the electrode material and thus the stability and flexibility of the electrode material, and, for example, its adhesion to a substrate and the ionic conduction, may advantageously be improved. Thus, the long-term stability and the aging characteristics may in turn be further improved and the length of the service life of the cell may be further increased.

As is subsequently explained, the ionic conduction may be further increased due to additional measures. In particular, an ionic conduction, in particular, in a dry-cell battery, may thus advantageously be achieved, which may be improved with respect to existing dry-cell battery concepts, but also potentially with respect to conventional liquid electrolyte batteries.

Lithium argyrodites may be understood, in particular, as compounds which derive from the mineral argyrodite with the general chemical formula Ag₈GeS₆; silver (Ag) being substituted by lithium (Li), and Germanium (Ge) and/or Sulfur (S) being substituted by other elements, for example, of the groups III, IV, V, VI, and/or VII of the main group elements.

Examples for lithium argyrodites are
compounds of the general chemical formula:

Li₇PCh₆

where Ch stands for sulfur (S) and/or oxygen (O) and/or selenium (Se), for example, sulfur (S) and/or selenium (Se);
compounds of the general chemical formula:

Li₆PCh₅X

where Ch stands for sulfur (S) and/or oxygen (O) and/or selenium (Se), for example, sulfur (S) and/or oxygen (O), and X stands for chlorine (Cl) and/or bromine (Br) and/or iodine (I) and/or fluorine (F), for example, X stands for chlorine (Cl) and/or bromine (Br) and/or iodine (I);
compounds of the general chemical formula:

Li_{7-δ}BCh_{6-δ}X_{δ}

where Ch stands for sulfur (S) and/or oxygen (O) and/or selenium (Se), for example, sulfur (S) and/or selenium (Se), B stands for phosphorus (P) and/or arsenic (As), X stands for chlorine (Cl) and/or bromine (Br) and/or iodine

(I) and/or fluorine (F), for example, X stands for chlorine (Cl) and/or bromine (Br) and/or iodine (I), and 0≦δ≦1.

For example, lithium argyrodites are known with the chemical formulae: Li₇PS₆, Li₇PSe₆, Li₆PS₅Cl, Li₆PS₅Br, Li₆PS₅I, Li_{7-δ}PS_{6-δ}Cl_{δ}, Li_{7-δ}PS_{6-δ}Br_{δ}, Li_{7-δ}PS_{6-δ}I_{δ}, Li_{7-δ}PSe_{6-δ}Cl_{δ}, Li_{7-δ}PSe_{6-δ}Br_{δ}, Li_{7-δ}PSe_{6-δ}I_{δ}, Li_{7-δ}AsS_{6-δ}Br_{δ}, Li_{7-δ}AsS_{6-δ}I_{δ}, Li₆AsS₅I, Li₆AsSe₅I, Li₆PO₅Cl, Li₆PO₅Br, Li₆PO₅I.

Lithium argyrodites are described, for example, in the publications: Angew. Chem. Int. Ed., 2008, 47, 755-758; Z. Anorg. Allg. Chem., 2010, 636, 1920-1924; Chem. Eur J;, 2010, 16, 2198-2206; Chem. Eur. J., 2010, 16, 5138-5147; Chem. Eur. J., 2010, 16, 8347-8354; Solid State Ionics, 2012, 221, 1-5; Z. Anorg. Allg. Chem., 2011, 637, 1287-1294; and Solid State Ionics, 2013, 243, 45-48.

In particular, sulfur-containing or sulfidic lithium argyrodites may be used, for example, in which Ch stands for sulfur (S).

Lithium argyrodites may, in particular, be manufactured by a mechanical-chemical reaction process, for example, where raw materials, like lithium halogenides, for example, LiCl, LiBr, and/or LiI, and/or lithium chalcogenides, for example, Li₂S, and/or Li₂Se, and/or Li₂O, and/or chalcogenides from group V of the main group, for example, P₂S₅, P₃Se₅, Li₃PO₄, in particular, in stoichiometric amounts, may be milled together. This may be carried out, for example, in a ball mill, in particular, a high energy ball mill, for example, with a speed of 600 rpm. In particular, the milling may take place under a protective gas atmosphere.

Within the scope of one specific embodiment, the at least one solid lithium-ion conductor is selected from the group of lithium argyrodites, sulfur glasses (sulfidic glasses), phosphate glasses, germanium glasses, and/or lithium ion conducting glasses based on the general chemical formula: LiX:MY, where LiX stands for one or multiple lithium compounds, and MY stands for one or multiple oxides, sulfides, and/or selenides, in particular, oxides of barium, aluminum, molybdenum, tungsten, phosphorus, silicon, germanium, arsenic, and/or niobium.

These solid lithium-ion conductors have proven to be particularly advantageous as they may have a high lithium ion conductivity and low contact transition resistances at the grain boundaries within the material and to other components, for example, a dry-cell battery, for example, electrode active material, for example, cathode active material, for example, anode active material. Thus, the long-term stability and performance of a cell, or battery, for example, dry-cell batteries, equipped with the electrode material may be further improved. Due to the use of mixtures of solid lithium-ion conductors, transition resistances may be, if necessary, further reduced between the solid lithium-ion conductors and to other components of the electrode material, the electrode, or the cell/battery, and the ionic conduction may be further optimized.

Examples for lithium ion conducting sulfur glasses (sulfidic glasses) are Li₁₀GeP₂S₁₂, Li₂S—(GeS₂)—P₂S₅, and Li₂S—P₂S₅. For example, germanium-containing sulfur glasses (sulfidic glasses) may be used, for example, Li₁₀GeP₂S₁₂ and/or Li₂S—(GeS₂)—P₂S₅, in particular, Li₁₀GeP₂S₁₂. Germanium-containing sulfidic lithium-ion conductors may advantageously have a high lithium ion conductivity and high chemical stability.

Lithium substituted NASICON may be included among the phosphate glasses.

Lithium ion conducting glasses based on the general chemical formula, LiX:MY, may be manufactured as binary and ternary or from more basic elements. Lithium ion conducting glasses based on the general chemical formula, LiX:MY, may therefore include two or multiple compounds LiX and/or two or multiple compounds MY and, if necessary, one or multiple further compounds, for example, aluminum chloride, for example, AlCl₃. For example, lithium ion conducting glasses based on the general chemical formula, LiX:MY, may be manufactured from three basic elements corresponding to the general formula, MX:M₂O:AₓO_{y}, where MX stands for a doping salt, for example, lithium salt, for example, LiI, etc.; M₂O stands for at least one glass modifier, for example, a (different) lithium salt, for example, Li₂O, etc.; and AₓO_{y} stands for at least one glass former, for example, at least one oxide, sulfide, and/or selenide, in particular, oxide, for example, of boron, aluminum, molybdenum, tungsten, phosphorus, silicon, germanium, arsenic, and/or niobium, for example, B₂O₃, MoO₃, WO₃, P₂O₅, SiO₂, As₂O₅, etc.

LiX may be selected, for example, from the group of chlorides, bromides, iodides, oxides, sulfides, sulfates, and/or phosphates of lithium. For example, LiX may stand for LiCl, LiBr, LiI, Li₂O, Li₂S, Li₂SO₄, and/or LiPO₃.

MY may stand, for example, for B₂O₃, Al₂O₃, Al₂S₃, Al₂Se₃, AlCl₃, MoO₃, MoS₃, MoSe₃, MoO₂, MoS₂, MoSe₂, MoO, MoS, MoSe, WO₃, WS₃, WSe₃, WO₂, WS₂, WSe₂, LiWO₃, WO₂, WS₂, WSe₂, W₂O₃, W₂S₃, W₂Se₃, P₂O₅, P₂S₅, P₂Se₅, PsO₃, P₂S₃, P₂Se₃, SiO₂, SiS₂, SiSe₂, SiO, SiS, SiSe, Si₂S₂, GeO₂, GeS₂, GeSe₂, GeO, GeS, GeSe, As₂O₅, As₂S₅, As₂O₄, As₂S₄, As₂Se₄, As₂O₃, AsS₃, As₂Se₃, Nb₂O₅, LiNbO₃, NbO₂, NbS₂, NbSe₂, NbO, NbS, and/or NbSe.

In particular, in lithium-ion conducting glasses based on the general chemical formula, LiX:MY, LiX may stand for LiCl, LiBr, LiI, Li₂O, Li₂S, Li₂SO₄, and/or LiPO₃, and MY may stand for B₂O₃, Al₂O₃, AlCl₃, MoO₃, WO₃, P₂O₅, P₂O₃, SiO₂, SiS₂, Si₂S₂, GeS₂, As₂O₅, and/or Nb₂O₅.

Lithium ion conducting glasses based on the general chemical formula, LiX:MY, and, in particular, corresponding to the general formula, MX:M₂O:AₓO_{y} are described, in particular, in the review of, “Ion Conduction in Superionic Glassy Electrolytes,” by A. Chandra, A. Bhatt, in: An Overview, in J. Mater. Sci. Technol. 2013, 29(3), 193-208. Examples for lithium ion conducting glasses of the general chemical formula, LiX:MY, or MX:M₂O:AₓO_{y}, are 61 B₂O₃:34.1 L₂O:4.9 LiI; 29.4 Li₂O:58.8 SiO₂:11.7 Li₂SO₄; 2 LiS:28 Si₂S₂:30 LiI; 37.5 SiS₂:37.5 Li₂S:25 LiCl; 40 Li₂O:8 Al₂O₃:52 B₂O₃; 50 Li₂S:50 GeS₂; 80 LiWO_{3.5}:20 LiCl, 40 LiO₂:35 B₂O₃:25 LiNbO₃; 62 Li₂O:38 SiO₂; 30 LiI:41 Li₂O:29 PsO₅; and 88 LiPO₃:12 AlCl₃.

Within the scope of another specific embodiment, the at least one solid lithium-ion conductor is selected from the group of lithium argyrodites. Lithium argyrodites are advantageously distinguished by particularly low contact transition resistances at the grain boundaries within the material and to other components, for example, a dry-cell battery, for example, electrode active material, for example, cathode active material, for example, anode active material. Thus, a particularly good ionic conduction may advantageously be achieved at and within the grain boundary surfaces. Advantageously, lithium argyrodites also have a low transition resistance between grains even without a sintering process. This advantageously enables the simplification of the manufacture of the electrode material and a cell or battery, but also advantageously expands the lineup of materials that may thus be used together.

If necessary, the ionic conduction may be further improved by doping the at least one solid lithium-ion conductor. For example, the doping may be carried out via diffusion of doping atom precursors, implantation, and/or direct manufacturing using the correct dopant “density”.

Within the scope of another specific embodiment, the material includes surface-modified and/or aspherical particles, including the at least one solid lithium-ion conductor, for example, selected from the group of lithium argyrodites and lithium ion conducting glasses.

The surface modification may be carried out, for example, in such a way that the particles including the at least one solid lithium-ion conductor have an electrically conductive and/or lithium ion conductive coating and/or a surface structuring. Due to the electrically conductive and/or lithium ion conductive coating and/or the surface structuring, contact transition resistances for electrons and/or lithium ions may advantageously be reduced.

The coating may, for example, include carbon, for example, graphite and/or carbon nanotubes, or be formed from the same. An electrically conductive coating may advantageously be provided using carbon. In particular, the coating may include lithium functionalizable or functionalized, for example, lithiatable or lithiated carbon, for example, lithiated graphite and/or lithiated carbon nanotubes. Thus, the coating may be configured to be conductive for electrons as well as for lithium ions.

For example, the particles or particle cores may be formed from the at least one solid lithium-ion conductor, for example, selected from the group of lithium argyrodites and lithium conducting glasses, and have an electrically conductive and/or lithium ion conductive coating, for example, made of carbon, if necessary lithium functionalizable or functionalized carbon, and/or a surface structuring.

It is, however, also possible to form the particles or the particle cores and the coating from different solid lithium-ion conductors.

For example, the particles including the at least one solid lithium-ion conductor, in particular, selected from the group of lithium argyrodites and lithium ion conducting glasses, may thereby include at least one solid lithium-ion conductor, for example, selected from the group of lithium argyrodites, lithium ion conducting glasses, and lithium ion conducting ceramics, in particular, with garnet structures.

Within the scope of one embodiment, the coating is thereby formed from the at least one solid lithium-ion conductor, in particular, selected from the group of lithium argyrodites and lithium ion conducting glasses, and the particles or particle cores are formed from the at least one additional solid lithium-ion conductor, for example, selected from the group of lithium argyrodites, lithium ion conducting glasses, and lithium ion conducting ceramics, in particular, with garnet structures. This has proven to be particularly advantageous, since contact transition resistances may be reduced by the lithium argyrodites and lithium ion conducting glasses, in particular, where the material of the particles or particle cores may be selected from a broad material lineup.

The surface structuring may, for example, be configured in the form of, in particular, introduced elevations and/or depressions in the particle surface. For example, the surface structuring may be configured to form “hook-and-loop”-like connections between particles. Thus, the contact among the particles including the solid lithium-ion conductor may be advantageously improved and in this way, contact transition resistances may be reduced, in particular, for lithium ions.

Aspherical particles may be understood in particular, as particles with a form deviating from a spherical shape. For example, aspherical particles may be platelet-shaped particles and/or rod-shaped particles. The contact among the particles may be advantageously improved by platelet-shaped particles, and in this way, contact transition resistances, in particular, for lithium ions, may be reduced. A lithium ion transport across long stretches, in particular, along the longitudinal axis of the particles, may advantageously be affected by platelet-shaped particles, and in particular, by rod-shaped particles, and in this way, the lithium ion conduction may be improved.

Within the scope of another specific embodiment, the at least one, in particular, organic binder is a polymeric binder. Organic and, in particular, polymeric binders have proven particularly advantageous with respect to the mechanical stability and flexibility of the electrode material.

Basically, the at least one, in particular, organic binder may be lithium ion conducting and also lithium ion non-conducting. If necessary, the at least one binder may include an intrinsic lithium-ion conductor or may be such.

For example, the at least one binder may be or include polyethylene oxide (PEO) and/or a polysaccharide (or a cellulose derivative), like polyglucosamine (Chitosan), and/or polyvinylidene fluoride (PVdF).

Within the scope of another specific embodiment, the at least one binder may be lithium ion conducting. Thus, a component, which is otherwise electrochemically passive and has no functionality within the context of energy storage, and functions, for example, only for fixing particles and/or as fill material, may be configured to be electrochemically active. This, in turn, advantageously enables an improvement in the performance of the electrode material or a cell equipped with the same, and to reduce passive and, if necessary, other components, and thus to increase, if necessary, the energy density.

Within the scope of a configuration of this specific embodiment, the at least one, in particular, organic binder is intrinsically lithium ion conducting.

In order to provide binders, which are not intrinsically lithium ion conducting, like polyethylene oxide (PEO) and/or a polysaccharide (or a cellulose derivative), for example, Chitosan, and/or polyvinylidene fluoride (PVdF), with a lithium ion conductivity, or to increase the lithium ion conductivity of an intrinsically lithium ion conducting binder, the at least one binder may, however, also include at least one conducting salt, in particular, a lithium conducting salt.

Within the context of an alternative or additional configuration of this specific embodiment, the at least one, in particular, organic binder therefore includes at least one conducting salt, in particular, a lithium conducting salt. For example, the at least one conducting salt may be selected from the group including lithium hexafluorophosphate (LiPF₆), lithium bis-trifluoromethanesulfonimide (LiTFSI), Lithium tetrafluoroborate (LiBF₄), lithium bis oxalato borate, and mixtures thereof.

Within the scope of another specific embodiment, the electrode material includes in addition at least one, in particular, electrically and ionically conducting mixed conductor. Mixed conductors may advantageously have a high ionic and electrical conductivity. The use of mixed conductors therefore advantageously enables the partial exchange of components, which are only electrically conductive and, for example, function for forming purely electrically conducting networks for the electron transport, for example, electrically conductive materials, like graphite and/or conductive carbon black, and/or which are only ionically conductive, for example, solid lithium-ion conductors.

This, in turn, advantageously enables an improvement in the performance of the electrode material or a cell equipped with the same, and a reduction in components, and thus, if necessary, an increase in the energy density.

Within the scope of a particular configuration of this specific embodiment, the at least one mixed conductor is selected from the group of lithium titanium oxides, for example, of the general chemical formula, LiₓTi_{y}O_{z}, which may be in a form with a mixed valence of titanium ions, for example, Li₇Ti₅O₁₂ with mixed Ti³⁺/Ti⁴⁺ valence, or in the spinel form with the general chemical formula, Li₁₊ₓTi₂₋ₓO₄, where 0≦x≦0.33, for example, with an average valence of approximately 3.5. These types of lithium titanium oxides may advantageously have a high ionic and electrical conductivity.

If necessary, electrically conductive materials, like graphite and/or carbon black, may be completely exchanged for mixed conductors.

In order to achieve a sufficient electrical conductivity during the exchange of electrical conductive materials for mixed conductors, it may, however, be advantageous to combine the mixed conductor or the mixed conductors with one or multiple electrically conductive materials.

The proportion of electrically conductive material may be at least reduced by the at least one mixed conductor.

If necessary, the electrode material may additionally include at least one electrically conductive material. Thus, the electron transport in the electrode may advantageously be improved or ensured.

For example, the at least one electrically conductive material may be a material based on carbon. For example, the at least one electrically conductive material may be selected from the group including graphite, carbon black, for example, conductive carbon black, carbon nanotubes (CNT), and graphene.

In particular, the electrode material may include particles of one electrically conductive material, for example, graphite, with an average particle diameter of ≧2 μm, for example, from ≧3 μm through ≦20 μm, and particles of one electrically conductive material, for example, carbon black/conductive carbon black, with an average particle diameter of ≦500 nm. Due to the different particle sizes, the electrically conductive material with the large average particle diameter, for example, graphite, may take on the role of a “highway”, that is, the electrical connection between farther remote areas in the electrode, and the electrically conductive material with the smaller average particle diameter, for example, carbon black, may take on the role of the local electrical connection including the smallest corners and angles in the electrode.

A further optimization of the ionic conduction may be achieved by the interplay of different components, in particular, an optimization of the distribution of the components, in particular, of the at least one solid lithium-ion conductor.

For example, the electrode material may include very fine particles encompassing the at least one solid lithium-ion conductor, for example, with an average particle diameter of ≦500 nm, for example, of ≦100 nm, or with a quasi zero-dimensional particle shape, for example, with an average particle diameter of ≦50 nm, and, in particular, a very narrow particle size distribution, for example, similar to a colloid. Thus, the solid lithium-ion conductor may advantageously also occupy the smallest spaces, and thus increase the ionic conduction.

Alternatively or additionally, the electrode material may include coarser particles including the at least one solid lithium-ion conductor selected from the group of lithium argyrodites and lithium ion conducting glasses, for example, with an average particle diameter of ≧2 μm, for example, of ≧3 μm through 20 μm, with a faster ionic conduction over larger stretches. Due to the addition of finer particles encompassing the at least one solid lithium-ion conductor, for example, with an average particle diameter of ≦500 nm, however, slower locally more finely distributed interconnections may be achieved, due to the fineness.

Within the scope of another specific embodiment, the material therefore includes particles which encompass the at least one solid lithium-ion conductor and have an average particle diameter of ≧2 μm, for example, of ≧3 μm, for example, up to ≦20 μm, and particles which encompass the at least one solid lithium-ion conductor and have an average particle diameter of ≦500 nm, for example, ≦100 nm. In particular, the material may thereby have an at least bimodal distribution of the particles encompassing the at least one solid lithium-ion conductor. Due to the different particle sizes, the at least one solid lithium-ion conductor with the large average particle diameter may take on the role of a “highway,” that is, the ionic connection between farther remote areas in the electrode, and the at least one solid lithium-ion conductor with the small average particle diameter may take on the role of the local ionic connection including the smallest corners and angles in the electrode. The at least one solid lithium-ion conductor with the large average particle diameter may thereby be basically made from a different material than the at least one solid lithium-ion conductor with the small average particle diameter; however, the at least one solid lithium-ion conductor with the large average particle diameter and the at least one solid lithium-ion conductor with the small average particle diameter may be made from the same material, for example, selected from the group of lithium argyrodites and lithium-ion conducting glasses, for example, selected from the group of lithium argyrodites. Thus, transition resistances may be advantageously minimized and the ionic conduction between the two solid lithium-ion conductors may be optimized.

Alternatively or additionally, the electrode material may include solid lithium-ion conductors with different particle shapes.

For example, the electrode material may include at least one solid lithium-ion conductor with a two-dimensional particle shape (2D flakes) and/or at least one solid lithium-ion conductor with a one-dimensional particle shape (1D rods), and/or at least one solid lithium-ion conductor with a quasi zero-dimensional particle shape (fine powder). Solid lithium-ion conductors with these types of particle shapes may be manufactured using milling, gas phase, and/or liquid phase processes.

It is thereby possible to use no solid lithium-ion conductors with a quasi zero-dimensional particle shape, but instead to use only solid lithium-ion conductors with a two-dimensional and/or one-dimensional particle shape.

In particular, however, solid lithium-ion conductors with a two-dimensional and/or one-dimensional and/or quasi zero-dimensional particle shape may be combined with one another.

Due to the different particle shapes, for example, the at least one solid lithium-ion conductor with a two-dimensional particle shape and/or the at least one solid lithium-ion conductor with a one-dimensional particle shape may take on the role of the “highway,” that is, the ionic connection between farther remote areas in the electrode, and, if necessary, the at least one solid lithium-ion conductor with a quasi zero-dimensional particle shape may take on the role of the local ionic connection including the smallest corners and angles in the electrode.

The at least one solid lithium-ion conductor with a two-dimensional particle shape and/or the at least one solid lithium-ion conductor with a one-dimensional particle shape, and/or the at least one solid lithium-ion conductor with a quasi zero-dimensional particle shape may thereby be basically formed from different materials. However, the at least one solid lithium-ion conductor with a two-dimensional particle shape and/or the at least one solid lithium-ion conductor with a one-dimensional particle shape, and/or the at least one solid lithium-ion conductor with a quasi zero-dimensional particle shape may be made of the same material, for example, selected from the group of lithium argyrodites and lithium ion conducting glasses, for example, selected from the group of lithium argyrodites. Thus, transition resistances may advantageously be minimized and the ionic conduction between the two solid lithium-ion conductors may be optimized.

Within the scope of another specific embodiment, the at least one solid lithium-ion conductor, for example, selected from the group of lithium argyrodites and lithium ion conducting glasses, for example, selected from the group of lithium argyrodites, is configured in the form of an ion conductor bus, which is embedded in the at least one electrode active material, for example, the cathode active material or the anode active material.

An ion conductor bus may be understood, in particular, as an ion transport and/or distribution structure, for example, as an ion transport and/or distribution network, in particular, which may be created or set up in a targeted way.

For example, the ion conductor bus may be a one-dimensional bus (1D bus) in the shape of a “forest” made of, for example, standing, for example, vertical rods, and/or nanowires made from the at least one solid lithium-ion conductor. Thus, for example, a direct ion transport, in particular, may be implemented through the electrode material, for example, between a cathode current collector and a lithium ion conducting solid electrolyte separator.

The ion conductor bus may, however, also be a two-dimensional nanowires, and or webs, for example, having a certain width, made from the at least one solid lithium-ion conductor. Thus, an improved connection of the electrode material, for example, the cathode active material or the anode active material, may advantageously be achieved to the ion conductor.

In particular, the ion conductor bus may be a three-dimensional bus (3D bus) in the form of a completely crosslinked network, for example, made from rods, nanowires, and or webs, or a “sponge” made from the at least one solid lithium-ion conductor. Thus, a particularly good connection of the electrode material to the ion conductor may advantageously be achieved.

A three-dimensional ion conductor bus of this type may be made, for example, from a mass which includes particles of at least one inorganic material, for example, lithium argyrodite, configured for sinter-free formation of a lithium ion conducting network, and at least one binder.

Within the scope of another specific embodiment, the electrode material is therefore formed from a mass, which includes particles of at least one inorganic material, for example, lithium argyrodite, configured for sinter-free formation of a lithium ion conducting network, and at least one, in particular, organic binder. Furthermore, the mass may include one or multiple of the previously described electrode material components.

An inorganic material configured for sinter-free formation of a lithium ion conducting network may be understood, in particular, as an inorganic material from whose particles a lithium ion conducting network may be formed, in particular, with a lithium ion conductivity of >10⁻³ S/cm, which may be of ≧10⁻⁴ S/cm or ≧10⁻³ S/cm, even at temperatures of below 1000° C., for example, ≦600° C.

In particular, the electrode material may be formed at temperatures of below 1000° C., for example, at ≦600° C., for example, at ≦100° C., and, in particular, unsintered. For example, the electrode material may be formed by compression, for example, by pressing, for example, by a press-melt process of the mass.

In particular, the at least one inorganic material, configured for sinter-free formation of a lithium ion conducting network, may be selected from the group of lithium argyrodites. Lithium argyrodites have proven particularly advantageous for a manufacturing method of this type.

The electrode material may be inexpensively and advantageously manufactured by a method of this type and may, in particular, have low grain boundary transition resistances and thus a good ionic conduction.

A three-dimensional ion conductor bus may, however, also be manufactured through self-organized network growth; (back) etching of pores in a compact electrode, filling of pores in an electrode matrix with solid lithium-ion conductors and, if necessary, mixed conductors, and, if necessary, curing, for example, with the aid of UV radiation, temperature, or chemical additives; galvanic growth through a pore network; and/or filling of pores with the aid of gas phase processes, for example, chemical vapor deposition (CVD) and/or atomic layer deposition (ALD) using solid lithium-ion conductors and, if necessary, mixed conductors.

If necessary, the electrode material, may be impregnated locally, in particular, subsequently, with a liquid component, for example, an ionic liquid, liquid electrolyte, etc.

Within the scope of another specific embodiment, the electrode material is formed using an aerosol deposition method. Thus, compact layers, low transition resistances, and a high ionic conduction may advantageously be achieved by a simple, and in particular, solvent-free method which is thus low in energy use and low in contamination.

If necessary, the electrode material may, however, also be configured as a printing paste for manufacturing a cathode with the aid of printing technology or made from the same.

Within the scope of another specific embodiment, the electrode material additionally includes at least one additional solid lithium-ion conductor. The at least one additional solid lithium-ion conductor may, for example, be selected from the group of lithium argyrodites, lithium ion conducting glasses, and lithium ion conducting ceramics, in particular, with a garnet structure.

It is additionally possible that the electrode material includes surface modified and/or aspherical particles encompassing the at least one electrode active material. The surface modified and/or aspherical particles encompassing the at least one electrode active material may be formed analogously to the already described surface modified and/or aspherical particles encompassing the at least one solid lithium-ion conductor.

Within the scope of an embodiment, the electrode material includes particles of at least one electrode active material which is provided with an electrically conductive and/or lithium ion conductive coating. The coating may thereby encompass the at least one solid lithium-ion conductor and/or carbon or be made of the same. For example, the at least one electrode active material may be coated with the at least one solid lithium-ion conductor and/or carbon.

Alternatively or in addition to the coating, the particles may have a surface structuring. The surface structuring may thereby be created to form “hook-and-loop”-like connections between particles.

Due to the preceding measures, the electrical and/or ionic connection of the electrode material may advantageously be improved and the long-term stability and performance further increased.

Within the scope of one particular embodiment, the material is a cathode material. In particular, the at least one lithiatable electrode active material may be a lithiatable cathode material.

Within the scope of a specific embodiment, the at least one cathode active material is a cathode active material with lithium ion intercalatable cathode active material.

For example, the at least one cathode active material may include lithium manganese spinel (LiMn₂O₄), lithium cobalt oxide (LiCoO₂), lithium iron phosphate (LiFePO₄), and or nickel, manganese, cobalt, and/or aluminum mixtures of different compounds, or be formed thereof.

Within the scope of one embodiment, however, the at least one cathode active material includes or is a lithium spinel made from manganese and/or cobalt and/or nickel, for example, lithium manganese spinel (LiMn₂O₄), and/or a lithium cobalt and/or lithium manganese and/or lithium nickel and/or lithium aluminum oxide, for example, lithium cobalt oxide (LiCoO₂). Lithium spinels and lithium oxides also have, for example, in contrast to lithium iron phosphate (LiFePO₄), an advantageously good ionic (through) conductivity, in particular, for lithium ions. Thus, the ionic conduction and the long-term stability and performance may be further advantageously optimized. Lithium manganese spinel is advantageously particularly inexpensive and environmentally compatible. Lithium cobalt oxide is characterized by a particularly high energy density.

Within the scope of one embodiment, the at least one cathode active material is coated with carbon and/or with solid lithium-ion conductors, for example, the at least one solid lithium-ion conductor. Thus, transition resistances may advantageously be further reduced and the ionic conduction further optimized.

Within the scope of another specific embodiment, the material is an anode material. The at least one lithiatable electrode active material may be a lithiatable anode material. For example, the at least one lithiatable anode material may be an anode active material intercalatable with lithium ions, for example, graphite.

With respect to further technical features and advantages of the electrode material according to the present invention, reference is explicitly made here to the explanations in conjunction with the cell according to the present invention, the battery according to the present invention, and to the use according to the present invention, and to the figures and the description of the figures.

A further subject matter of the present invention includes a lithium cell or a lithium battery including an electrode material according to the present invention. The battery according to the present invention may include, in particular, one or multiple cells according to the present invention.

The cell may include, in particular, a cathode (positive electrode) and an anode (negative electrode).

The cathode may, for example, include an electrode material according to the present invention, in particular, a cathode material, or be made from the same.

Alternatively or additionally, the anode may include an electrode material according to the present invention, in particular, an anode material, or be made from the same.

The lithium cell may, for example, be a lithium-ion cell or a lithium metal cell, or the lithium battery may be a lithium-ion battery or a lithium-metal battery. The lithium cell may, in particular, be a lithium-ion cell or the lithium battery may be a lithium-ion battery.

Within the scope of one specific embodiment, the lithium cell is a dry-cell battery cell (all solid state cell) and/or the lithium battery is a dry-cell battery (all solid state battery).

Alternatively or additionally, the lithium cell may be configured, for example, as a thin film battery cell or the lithium battery may be configured as a thin film battery. However, it is likewise possible to design the cell as a pouch cell.

Within the scope of another specific embodiment, a lithium ion conducting solid electrolyte is situated between the cathode and the anode and includes at least one solid lithium-ion conductor, in particular, the at least one solid lithium-ion conductor of the electrode material of the cathode (cathode material) and/or the anode (anode material) or is made from the same. By forming the lithium ion conducting solid electrolyte from the at least one solid lithium-ion conductor of the electrode material, for example, selected from the group of lithium argyrodites and lithium ion conducting glasses, for example, selected from the group of lithium argyrodites, transition resistances may be advantageously further reduced and the ionic conduction further optimized.

Furthermore, the cell may include an anode current collector, for example, made of copper, and a cathode current collector, for example, made of aluminum.

With respect to further technical features and advantages of the cell or battery according to the present invention, reference is explicitly made here to the explanations in conjunction with the electrode material according to the present invention and to the use according to the present invention, and to the figures and the description of the figures.

Furthermore, the present invention relates to the use of the electrode material according to the present invention or of the cell and/or battery according to the present invention.

For example, the electrode material, the cell, and/or the battery may be used for operation at elevated temperatures, for example, of ≧80° C. Thus, transition resistances and the ionic conductivity may advantageously be further improved. At elevated temperatures, for example, diffuse phase transitions, for example, solid/liquid, may advantageously occur, boundary surface resistances may be reduced and/or bulk conductivities may be greatly improved.

In particular, the electrode material, the cell, and/or the battery may be used, for example, as a micro battery for autonomous sensors.

The cell and/or the battery may, however, also be scaled up to be used in macroscopic applications, for example, a mobile device, like a mobile phone, for example, cell phones, and/or for an electric vehicle and/or home energy storage.

With respect to further technical features and advantages of the use according to the present invention, reference is explicitly made here to the explanations in conjunction with the electrode material according to the present invention, the cell according to the present invention, the battery according to the present invention, and to the figures and the description of the figures.

Additional advantages and advantageous embodiments of the subject matter according to the present invention are illustrated by the drawings and are explained in the subsequent description. It should be noted that the drawings have only a descriptive character and are not intended to restrict the present invention in any way.

### BRIEF DESCRIPTION OF THE DRAWINGS

FIG. 1 shows a schematic cross section through a specific embodiment of a cell according to the present invention as a pouch cell.

FIG. 2 shows a schematic cross section through a specific embodiment of a cell according to the present invention as a thin film battery cell.

FIG. 3 shows a greatly magnified, schematic representation of a specific embodiment of the cathode material of the cell shown in FIGS. 1 and 2.

### DETAILED DESCRIPTION

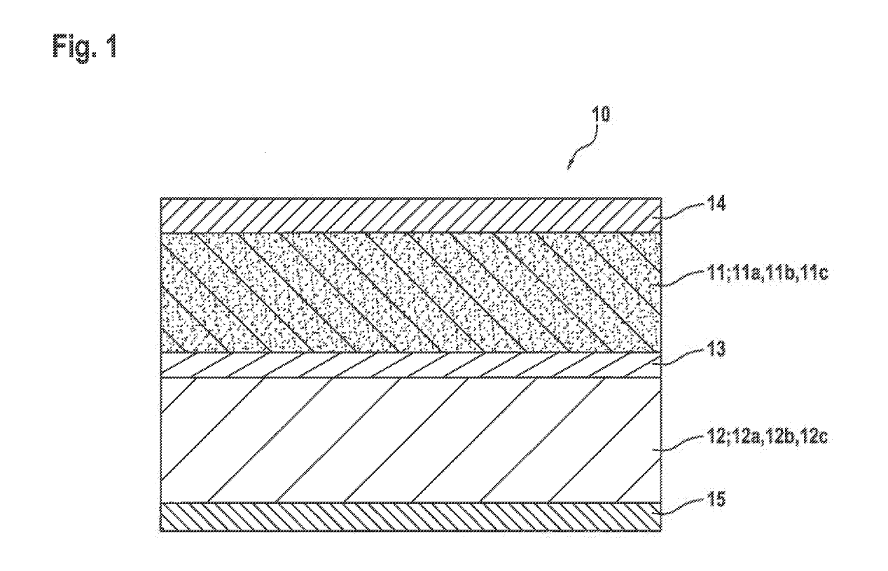

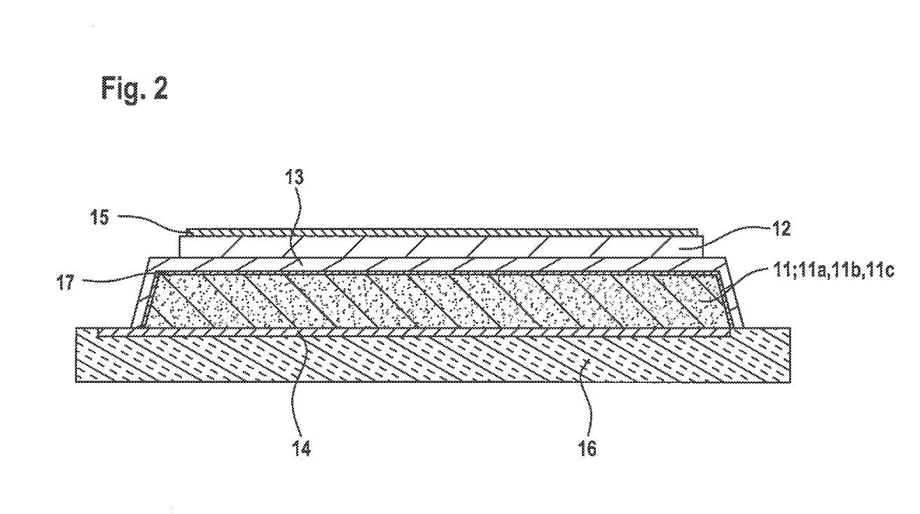

FIGS. 1 and 2 show cells 10 which include a cathode 11, an anode 12, and a lithium ion conducting solid electrolyte 13 situated between cathode 11 and anode 12. FIGS. 1 and 2 show that in each case, cathode 11 has a cathode current collector 14, for example, made of aluminum, and anode 12 has an anode current collector 15, for example, made of copper.

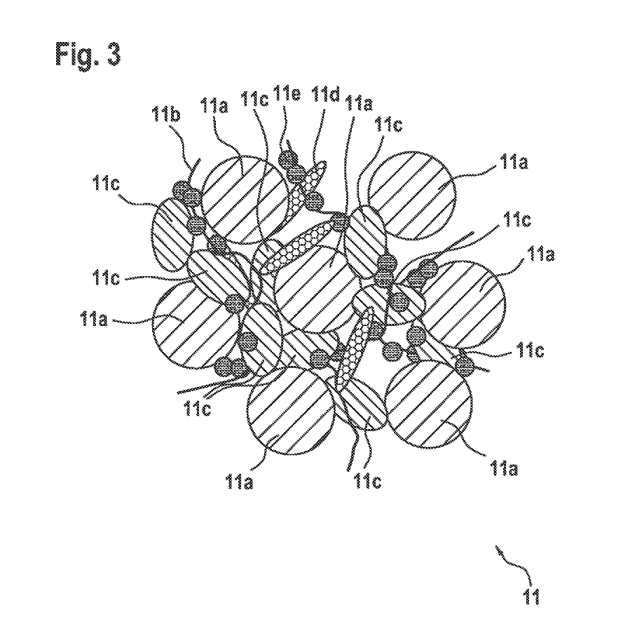

As is represented in greater detail in conjunction with the specific embodiment shown in FIG. 3, in cells 10 shown in FIGS. 1 and 2, cathode 11 may be formed from a cathode material 11, which includes a lithiatable cathode active material 11a, an organic binder 11b, and a solid lithium-ion conductor 11c. Alternatively or additionally, anode 12 may be formed from an anode material 12, which includes a lithiatable anode active material 12a, an organic binder 12b, and a solid lithium-ion conductor 12c. Solid electrolyte 13 may, in particular, encompass solid lithium-ion conductor 11c, 12c of cathode material 11 and anode material 12 or be made from the same.

Solid lithium-ion conductor 11c, 12c of cathode 11 and/or anode 12 and/or solid electrolyte 13 may, in particular, be selected from the group of lithium argyrodites and lithium ion conducting glasses, for example, the sulfur glasses, phosphate glasses, germanium glasses, and/or lithium ion conducting glasses of the general chemical formula, LiX:MY, where LiX stands for LiCl, LiBr, LiI, Li₂O, Li₂S, Li₂SO₄, and/or LiPO₃, and MY stands for B₂O₃, Al₂O₃, AlCl₃, MoO₃, WO₃, P₂O₅, P₂O₃, SiO₂, SiS₂, Si₂S₂, GeS₂, As₂O₅, and/or Nb₂O₅. In particular, at least one solid lithium-ion conductor 11c, 12c of cathode 11 and/or anode 12 and/or solid electrolyte 13 may be selected from the group of lithium argyrodites.

The structuring of cathode 11 in FIGS. 1 and 2 further indicates that a completely crosslinked ion conductor bus may be formed in cathode 11 by solid lithium-ion conductor 11c.

Within the scope of the specific embodiment shown in FIG. 1, cell 10 is configured as a pouch cell.

Within the scope of the specific embodiment shown in FIG. 2, cell 10 is configured as a thin film battery cell. Cathode 11 is applied here to a substrate 16, for example, a semiconductor substrate, for example, made from silicon, or a polymer substrate. FIG. 2 shows moreover that a transition layer 17, for example, made from an additional solid lithium-ion conductor or a mixture of solid lithium-ion conductors, may be formed between cathode material 11 and solid electrolyte 13 in order to achieve a minimization of transition resistance. Insofar as solid electrolyte 13 is formed from solid lithium-ion conductor 11c of cathode material 11 or from solid lithium-ion conductor 12c of anode material 12, then the transition layer may, if necessary, be omitted.

FIG. 3 is a greatly magnified, schematic representation of a specific embodiment of cathode material 11 of cell 10 shown in FIGS. 1 and 2. FIG. 3 shows that cathode material 11 includes a cathode active material 11a intercalatable with lithium ions, an organic binder 11b, and a solid lithium-ion conductor 11c.

Cathode active material 11a may be, for example, lithium manganese spinel and/or lithium cobalt oxide.

Binder 11b may be, in particular, lithium ion conducting. For example, binder 11b may include a lithium conducting salt and/or be intrinsically lithium ion conducting.

Solid lithium-ion conductor 11c may, in particular, be selected from the group of lithium argyrodites and lithium ion conducting glasses, for example, lithium argyrodites.

FIG. 3 illustrates that cathode material 11 may additionally include an electrically conductive material 11d with a large average particle diameter, for example, graphite, and an electrically conductive material 11e with a small average particle diameter, for example, carbon black/conductive carbon black. Alternatively or additionally, an electron transport may also be ensured by an electrical and ion conducting mixed conductor (not shown).

1-18. (canceled)

19. An electrode material for a lithium cell, comprising
at least one lithiatable electrode active material;
at least one organic binder; and
at least one solid lithium-ion conductor selected from the group of lithium argyrodites and lithium ion conducting glasses.

20. The material of claim 19, wherein the at least one solid lithium-ion conductor is selected from the group of lithium argyrodites, sulfur glasses, phosphate glasses, germanium glasses, and/or lithium ion conducting glasses based on the general chemical formula, LiX:MY, where LiX stands for LiCl, LiBr, LiI, Li₂O, Li₂S, Li₂SO₄, and/or LiPO₃, and MY stands for B₂O₃, Al₂O₃, AlCl₃, MoO₃, WO₃, P₂O₅, P₂O₃, SiO₂, SiS₂, Si₂S₂, GeS₂, As₂O₅, and/or Nb₂O₅.

21. The material of claim 19, wherein the at least one solid lithium-ion conductor is selected from the group of lithium argyrodites.

22. The material of claim 19, wherein the material includes surface-modified and/or aspherical particles encompassing the at least one solid lithium-ion conductor.

23. The material of claim 22, wherein the particles encompassing the at least one solid lithium-ion conductor have an electrically conductive and/or lithium ion conductive coating, the coating including the at least one solid lithium-ion conductor and or carbon, and/or the particles encompassing the at least one solid lithium-ion conductor have a surface structuring, the surface structuring being designed to form “hook-and-loop”-like connections between particles.

24. The material of claim 19, wherein the material includes particles encompassing of the at least one solid lithium-ion conductor with an average particle diameter of greater than or equal to 2 μm and particles encompassing the at least one solid lithium-ion conductor with an average particle diameter of less than or equal to 500 nm.

25. The material of claim 19, wherein the at least one solid lithium-ion conductor is in the form of an ion conductor bus, which is embedded in the at least one electrode active material, the ion conductor bus being a three-dimensional bus in the form of a completely crosslinked network, for example, a sponge made from the at least one solid lithium-ion conductor, or the ion conductor bus being a two-dimensional bus in the form of partially crosslinked rods, nanowires, and or webs made from the at least one solid lithium-ion conductor, or the ion conductor bus being a one-dimensional bus in the shape of a “forest” made of individual rods, and/or nanowires made from the at least one solid lithium-ion conductor.

26. The material of claim 19, wherein the material is formed from a mass, which includes particles of at least one inorganic material, configured for sinter-free formation of a lithium ion conducting network, and at least one organic binder.

27. The material of claim 19, wherein the material includes at least one additional solid lithium-ion conductor selected from the group of lithium argyrodites, lithium ion conducting glasses, and lithium ion conducting ceramics.

28. The material of claim 19, wherein the at least one organic binder is lithium ion conductive.

29. The material of claim 19, wherein the material includes at least one mixed conductor.

30. The material of claim 19, wherein the material includes particles of the at least one electrode active material which are provided with an electrically conductive and/or lithium ion conductive coating which includes the at least one solid lithium-ion conductor and/or carbon.

31. The material of claim 19, wherein the material is a cathode material and the at least one lithiatable electrode active material is a lithiatable cathode active material.

32. The material of claim 31, wherein the at least one cathode active material is a cathode active material intercalatable with lithium ions.

33. The material of claim 19, wherein the material is an anode material and the at least one lithiatable electrode active material is a lithiatable anode active material.

34. A lithium cell, comprising:
at least one electrode material, including
at least one lithiatable electrode active material;
at least one organic binder; and
at least one solid lithium-ion conductor selected from the group of lithium argyrodites and lithium ion conducting glasses.

35. The lithium cell of claim 34, wherein the lithium cell includes a dry-cell battery cell.

36. The lithium cell of claim 34, wherein the lithium cell includes a cathode and an anode, wherein a lithium ion conducting solid electrolyte is situated between the cathode and the anode, and encompasses the at least one solid lithium-ion conductor selected from the group of lithium argyrodites and lithium ion conducting glasses, and wherein at least one of the following is satisfied:
the cathode includes a material that is a cathode material and the at least one lithiatable electrode active material is a lithiatable cathode active material; and
the anode includes a material that is an anode material and the at least one lithiatable electrode active material is a lithiatable anode active material.

37. The material of claim 19, wherein the lithium cell includes a dry-cell battery cell.

38. The material of claim 19, wherein the material is formed from a mass, which includes particles of at least one inorganic material, configured for sinter-free formation of a lithium ion conducting network, and at least one organic binder, in particular, the material being formed at temperatures below 1000° C. and being, in particular, unsintered, or the material being formed using an aerosol deposition method.

39. The material of claim 19, wherein the material includes at least one additional solid lithium-ion conductor selected from the group of lithium argyrodites, lithium ion conducting glasses, and lithium ion conducting ceramics, in particular, with a garnet structure.

40. The material of claim 19, wherein the at least one organic binder is lithium ion conductive, in particular, the at least one organic binder including at least one lithium conducting salt and/or being intrinsically lithium ion conducting.

41. The material of claim 19, wherein the material includes at least one mixed conductor, in particular, the at least one mixed conductor being selected from the group of lithium titanium oxides.

42. The material of claim 31, wherein the at least one cathode active material is a cathode active material intercalatable with lithium ions, in particular, the at least one cathode active material including a lithium spinel made from manganese and/or a lithium cobalt and/or lithium manganese and/or lithium nickel and/or lithium aluminum oxide.

43. The material of claim 19, wherein the material is an anode material and the at least one lithiatable electrode active material is a lithiatable anode active material, in particular, an anode active material intercalatable with lithium ions.
